(19) United States
(12) Patent Application Publication
(10) Pub. No.: US 2016/0335699 A1
(43) Pub. Date: Nov. 17, 2016

(54) CANALPHONE SPECIFICATION SYSTEM AND METHOD

(71) Applicants: Brittany Gale Harvey, Apopka, FL (US); Jerry Harvey, Apopka, FL (US); Zachary Michael Penrod, Maitland, FL (US)

(72) Inventors: Brittany Gale Harvey, Apopka, FL (US); Jerry Harvey, Apopka, FL (US); Zachary Michael Penrod, Maitland, FL (US)

(21) Appl. No.: 13/587,167

(22) Filed: Aug. 16, 2012

(51) Int. Cl. G06F 3/048

(52) U.S. Cl. CPC G06Q 30/0631

(57) ABSTRACT

A canalphone specification system may include an interface to provide types of canalphones available for selection, appearance options to be applied to the selected canalphone, and user options to be added to the selected canalphone. The system may also include a computer-apparatus to generate a specification of the canalphone based upon the selected type of canalphone, the appearance options, and the user options.

### BACKGROUND

The embodiments relate to the field of canalphones.

There are many different types of personal listening devices such as headphones, earbuds, canalphones, and/or the like. Headphones are personal listening devices that are held in close proximately to the ear by some support system. Earbuds are small personal listening devices that are positioned directly in front of the ear canal and are substantially smaller than a person's outer ear. Similarly, canalphones are personal listening devices that are substantially smaller than a person's outer ear, but they differ from earbuds in that they are placed directly in one end of the ear canal. Both earbuds and canalphones are held in positioned by friction between the ear and the device rather than the support system found in most headphones.

Canalphones are also referred to as in-ear monitors due to how the canalphone is worn by a listener. In other words, a canalphone housing is worn in the ear of the user and not over and/or around the ear of the user. Some canalphones also serve as earplugs due to the way the canalphone limits noise external to the canalphone from entering the ear canal.

### SUMMARY

According to an embodiment, a canalphone specification system may include an interface to provide types of canalphones available for selection, appearance options to be applied to the selected canalphone, and user options to be added to the selected canalphone. The system may also include a computer-apparatus to generate a specification of the canalphone based upon the selected type of canalphone, the appearance options, and the user options.

The interface may separate types of canalphones into groupings based upon their technical components, separate appearance options into sets based upon color, no color, blacklight color, opacity, designer patterns, texture, and/or artwork, and separate user options into collections based upon cord preferences, side selection, and/or ambient venting. The interface may enable a user to position and/or size the artwork on the canalphone.

The system may further include a scanner to scan a user's ear to determine the canalphone's physical dimensions that will enable a proper fit of the canalphone in the user's ear, and to adjust the specification based upon the scan. The system may additionally include a nexus to make access to the computer-apparatus available to any interested consumer so the consumer can generate their own specification using the computer-apparatus.

The system may also include a point-of-sale interface linked to the computer-apparatus so that an order for the canalphone based upon the specification can be placed. The computer-apparatus may be positioned in a public location so that any interested consumer can have generated their own specification via the computer-apparatus.

Another aspect is a method for providing types of canalphones available for selection, and supplying appearance options to be applied to the selected canalphone. The method may include furnishing user options to be added to the selected canalphone, and generating a specification with a computer-apparatus of the canalphone based upon the selected type of canalphone, the appearance options, and the user options. The method may further include separating types of canalphones into groupings based upon their technical components.

The method may additionally include separating the appearance options into sets based upon color, no color, blacklight color, opacity, designer patterns, texture, and/or artwork. The method may also include enabling a user to position and/or size the artwork on the canalphone.

The method may also include separating the user options into collections based upon cord preferences, side selection, and/or ambient venting. The method may further include scanning a user's ear to determine the canalphone's physical dimensions that will enable a proper fit of the canalphone in the user's ear, and generating the specification based upon the scan.

The method may additionally include making access to the computer-apparatus available to any interested consumer so the consumer can generate their own specification using the computer-apparatus. The method may also include linking a point-of-sale interface to the computer-apparatus so that an order for the canalphone based upon the specification can be placed. The method may further include positioning the computer-apparatus in a public location so that any interested consumer can have generated their own specification via the computer-apparatus.

Another aspect is computer readable program codes coupled to tangible media to provide a canalphone specification. The computer readable program codes may be configured to cause the program to provide types of canalphones available for selection, and supply appearance options to be applied to the selected canalphone. The computer readable program codes may also furnish user options to be added to the selected canalphone, and generate a specification with a computer-apparatus of the canalphone based upon the selected type of canalphone, the appearance options, and the user options.

The computer readable program codes may further separate types of canalphones into groupings based upon their technical components. The computer readable program codes may additionally separate the appearance options into sets based upon at least one of color, no color, blacklight color, opacity, designer patterns, texture, and artwork.

The computer readable program codes may also enable a user to position and/or size the artwork on the canalphone. The computer readable program codes may further scan a user's ear to determine the canalphone's physical dimensions that will enable a proper fit of the canalphone in the user's ear, and generate the specification based upon the scan. The computer readable program codes may additionally link a point-of-sale interface to the computer-apparatus so that an order for the canalphone based upon the specification can be placed.

### BRIEF DESCRIPTION OF THE DRAWINGS

FIG. 1 is a schematic block diagram of a system in accordance with the embodiments.

FIG. 2 is a flowchart illustrating method aspects according to various embodiments.

FIG. 3 is a flowchart illustrating method aspects according to the method of FIG. 2.

FIG. 4 is a flowchart illustrating method aspects according to the method of FIG. 2.

FIG. 5 is a flowchart illustrating method aspects according to the method of FIG. 4.

FIG. 6 is a flowchart illustrating method aspects according to the method of FIG. 2.

FIG. 7 is a flowchart illustrating method aspects according to the method of FIG. 2.

FIG. 8 is a flowchart illustrating method aspects according to the method of FIG. 2.

FIG. 9 is a flowchart illustrating method aspects according to the method of FIG. 8.

FIG. 10 is a flowchart illustrating method aspects according to the method of FIG. 8.

### DETAILED DESCRIPTION

Embodiments will now be described more fully hereinafter with reference to the accompanying drawings, in which preferred embodiments are shown. Like numbers refer to like elements throughout.

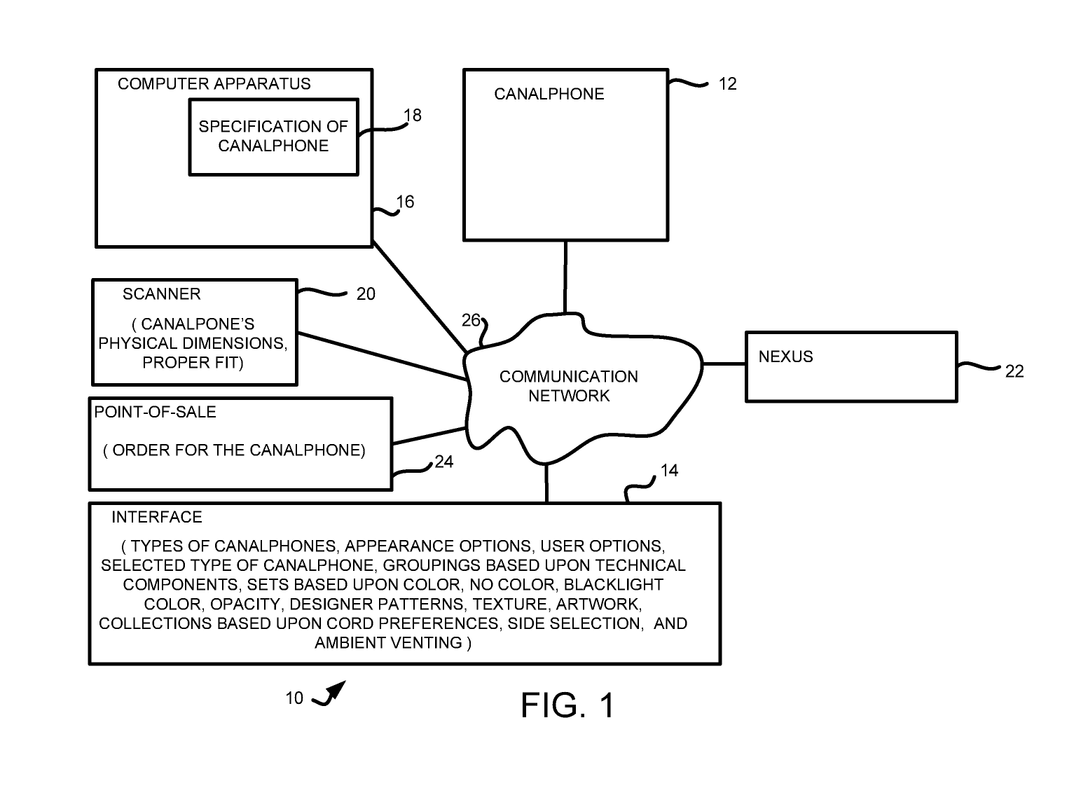

With reference now to FIG. 1, a canalphone specification system 10 is initially described. In one embodiment, the system 10 includes an interface 14 to provide types of canalphones 12 available for selection, appearance options to be applied to the selected canalphone, and user options to be added to the selected canalphone. The system 10 also includes a computer-apparatus 16 to generate a specification 18 of the canalphone 12 based upon the selected type of canalphone, the appearance options, and the user options.

In one embodiment, the specification 18 provides the physical and/or technical parameters that are used to build a physical version of the canalphone 12. In other words, the specification 18 is a detailed description of the design, components, and/or materials used to construct the canalphone 12. In another embodiment, the specification 18 is a digital file used by a computerized system to render portions of the canalphone 12 as a physical product. In another embodiment, the computer-apparatus 16 includes smartphones, laptops, kiosk interfaces, point-of-sale terminals, computer processors, and/or the like.

In one embodiment, the interface 14 separates the types of canalphones 12 into groupings based upon their technical components 15. For example, the types of canalphones 12 are separated based upon how many, or kinds, of audio drivers, e.g. technical components, are provided in a given type such as a type with two highs and two lows versus another type with four highs and four lows. In other words, a user can select a type of canalphone 12 at a given level of performance. In another embodiment, the technical components 15 comprise audio crossovers, audio amplifiers, and/or the like.

In one embodiment, the interface 14 separates appearance options into sets based upon color, no color, blacklight color, opacity, designer patterns, texture, and/or artwork. For instance, a user can customize the canalphone 12 according to their individual taste. In another embodiment, the interface 14 enables a user to position and/or size the artwork on the canalphone 12. Stated another way, the artwork can be scaled in size and/or located on the canalphone 12 according to the user's preference.

In one embodiment, the interface 14 separates the user options into collections based upon cord preferences, side selection, and/or ambient venting. Cord preferences relate to the cord carrying the audio signal into the canalphone 12 and includes length, color, and/or the like. Side selection relates to which canalphone 12 is being designed and includes left canalphone, right canalphone, or both. Ambient venting permits sound external to the canalphone 12 a pathway through the canalphone into the user's ear canal. A canalphone 12 can be built with or without ambient venting depending of the user's preference.

In one embodiment, the system 10 further includes a scanner 20 to scan the user's ear to determine the canalphone's physical dimensions that will enable a proper fit of the canalphone in the user's ear. For example, the scanner 20 is an in-ear 3D scanner that creates a model of portions of a subject's ear/ear canal system. The computer-apparatus 16 adjusts the specification 18 based upon the scan so that the specification incorporates the results of the scan into the specification. In other words, the system 10 produces a specification 18 that can be used to manufacture a canalphone 12 that frictionally engages the ear of a user (not shown) in its usage position with a proper fit.

In one embodiment, the system 10 additionally includes a nexus 22 to make access to the computer-apparatus 16 available to any interested consumer so the consumer can generate their own specification 18 using the computer-apparatus. For instance, the nexus 22 is a website, kiosk interface, point-of-sale terminal, and/or the like.

In one embodiment, the system 10 also includes a point-of-sale interface 24 linked to the computer-apparatus 16 so that an order for the canalphone 12 based upon the specification 18 can be placed. For example, the point-of-sale interface 24 is a banking system, credit card system, debit card system, payment system, and/or the like.

In one embodiment, the computer-apparatus 16 is positioned in a public location so that any interested consumer can have generated their own specification 18 via the computer-apparatus. For instance, a public location is an airport, shopping center, train station, and/or the like. In other words, the computer-apparatus 16 is provided by a retailer of the canalphone 12. In another embodiment, the computer-apparatus 16 is not owned by the retailer, e.g. the user owns the computer-apparatus.

In one embodiment, the system 10 includes a communications network 26, which enables a signal to travel anywhere within system 10 and/or to any other component/system connected to system 10. The communications network 26 is wired and/or wireless, for example. The communications network 26 is local and/or global with respect to system 10, for instance.

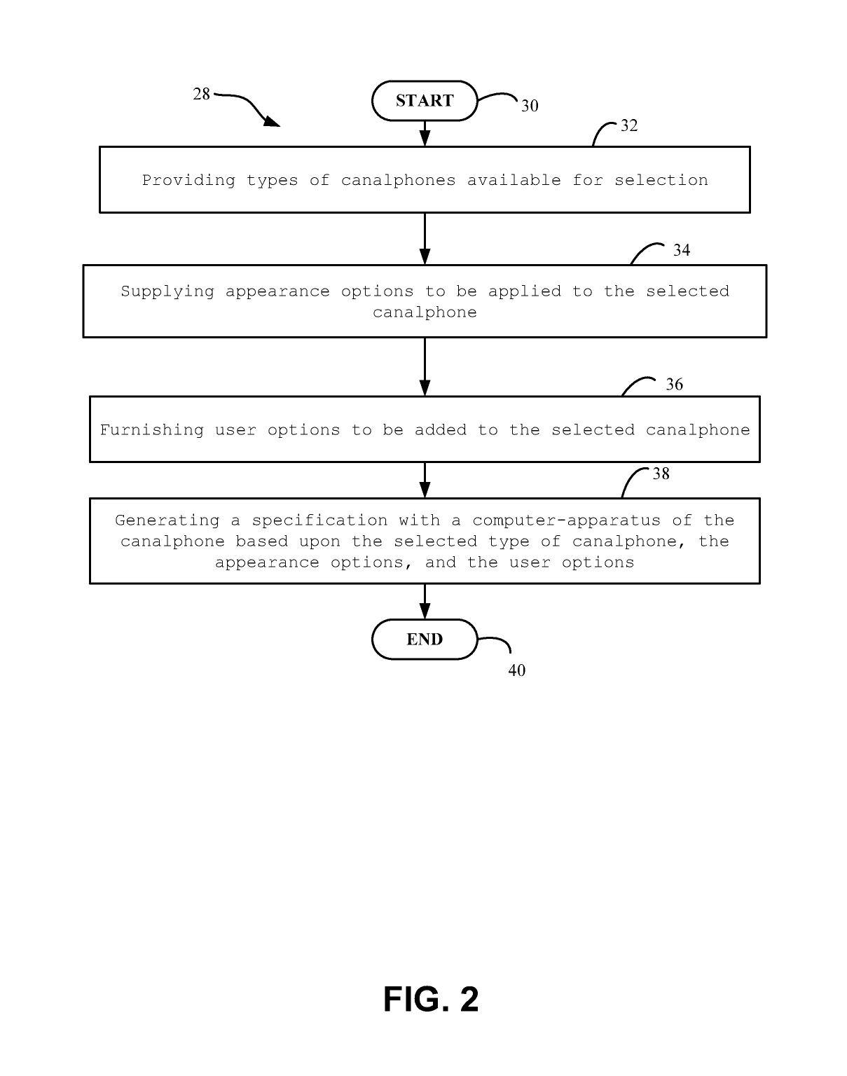

Another aspect is a method for generating a canalphone specification, which is now described with reference to flowchart 28 of FIG. 2. The method begins at Block 30 and may include providing types of canalphones available for selection at Block 32. The method may also include supplying appearance options to be applied to the selected canalphone at Block 34. The method may further include furnishing user options to be added to the selected canalphone at Block 36. The method may additionally include generating a specification with a computer-apparatus of the canalphone based upon the selected type of canalphone, the appearance options, and the user options at Block 38. The method ends at Block 40.

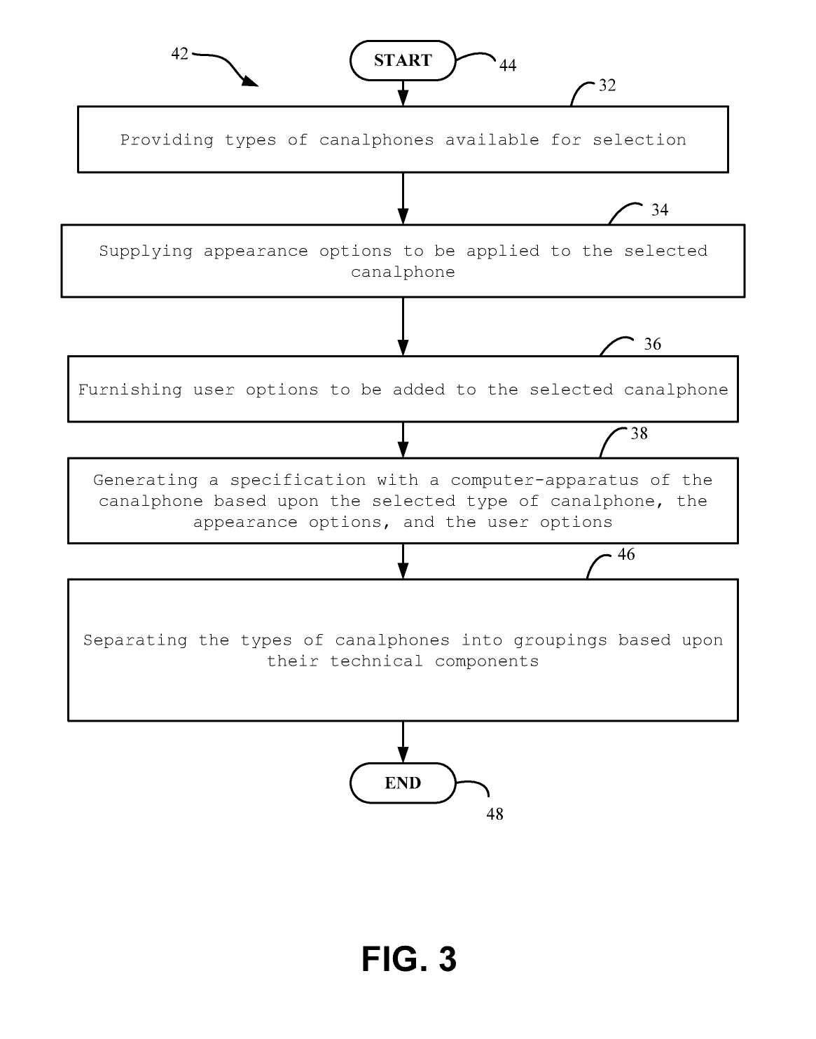

In another method embodiment, which is now described with reference to flowchart 42 of FIG. 3, the method begins at Block 44. The method may include the steps of FIG. 2 at Blocks 32-38. The method may also include separating the types of canalphones into groupings based upon their technical components at Block 46. The method ends at Block 48.

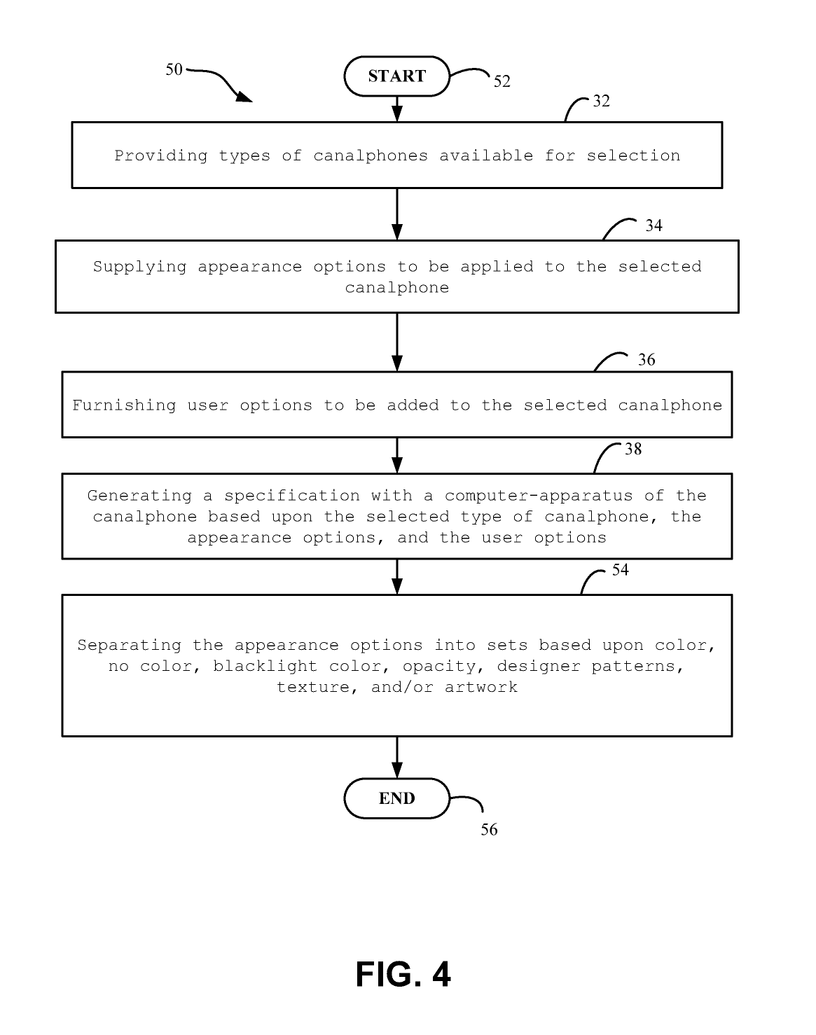

In another method embodiment, which is now described with reference to flowchart 50 of FIG. 4, the method begins at Block 52. The method may include the steps of FIG. 2 at Blocks 32-38. The method may also include separating the appearance options into sets based upon color, no color, blacklight color, opacity, designer patterns, texture, and/or artwork at Block 54. The method ends at Block 56.

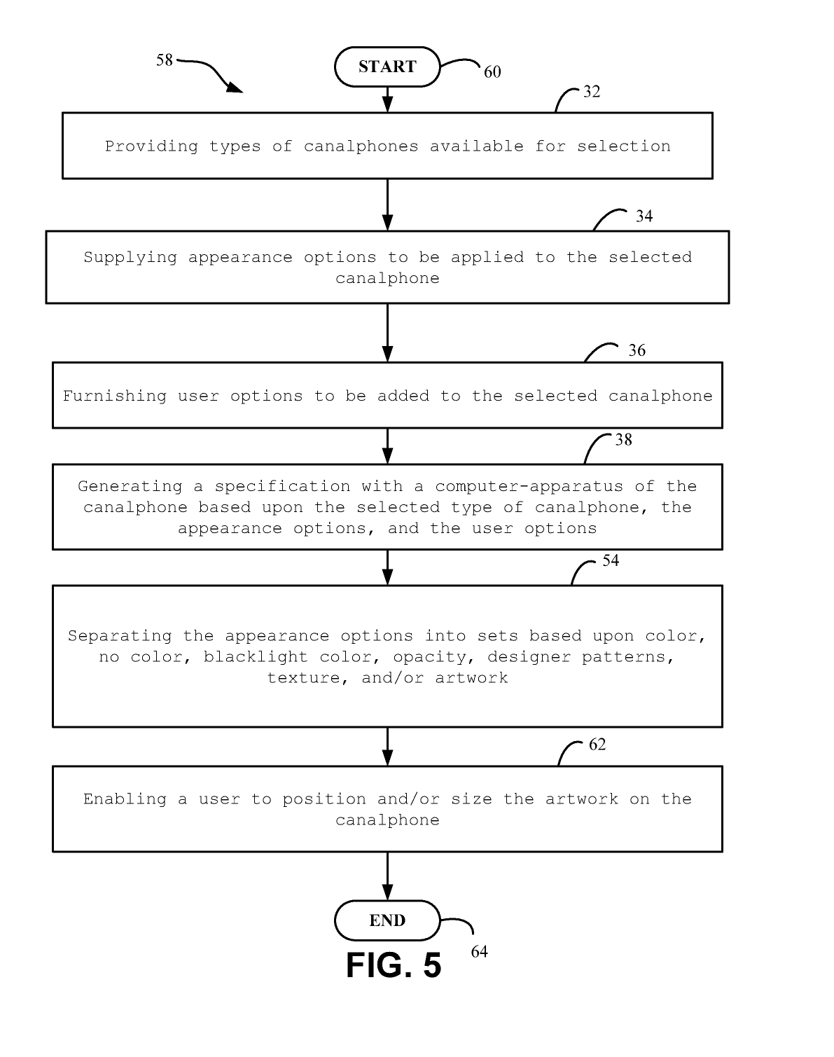

In another method embodiment, which is now described with reference to flowchart 58 of FIG. 5, the method begins at Block 60. The method may include the steps of FIG. 4 at Blocks 32-38 and 54. The method may also include enabling a user to position and/or size the artwork on the canalphone at Block 62. The method ends at Block 64.

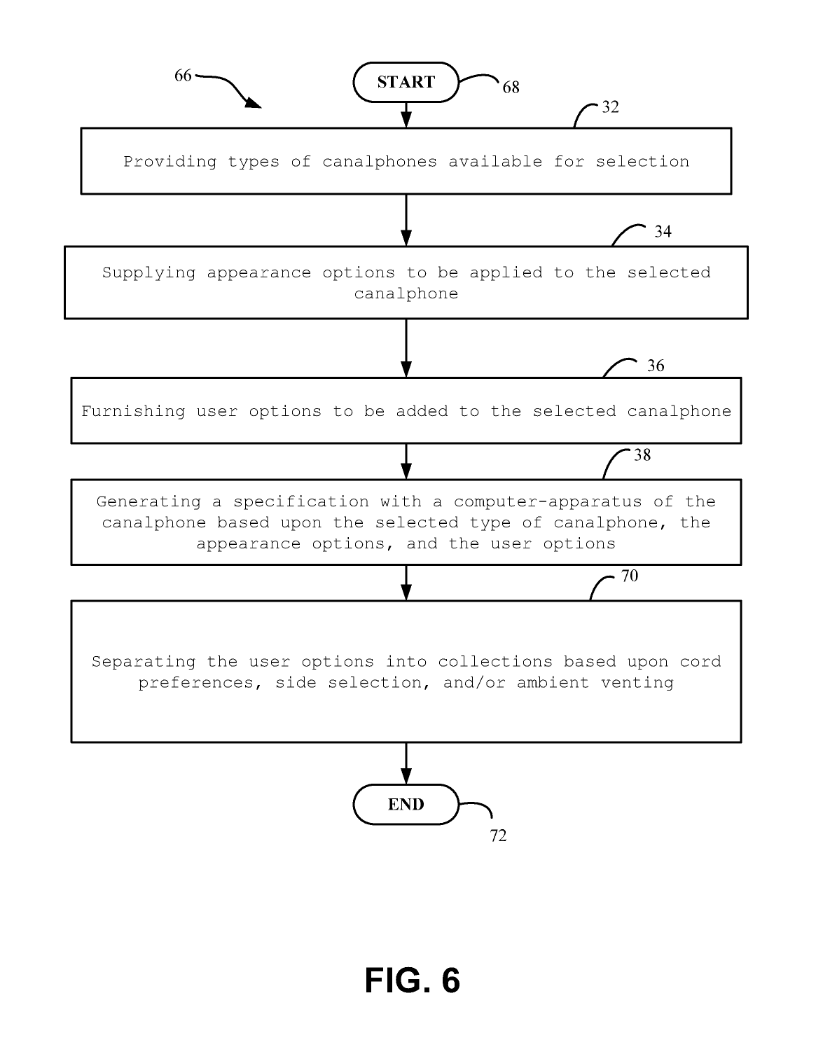

In another method embodiment, which is now described with reference to flowchart 66 of FIG. 6, the method begins at Block 68. The method may include the steps of FIG. 2 at Blocks 32-38. The method may also include separating the user options into collections based upon cord preferences, side selection, and/or ambient venting at Block 70. The method ends at Block 72.

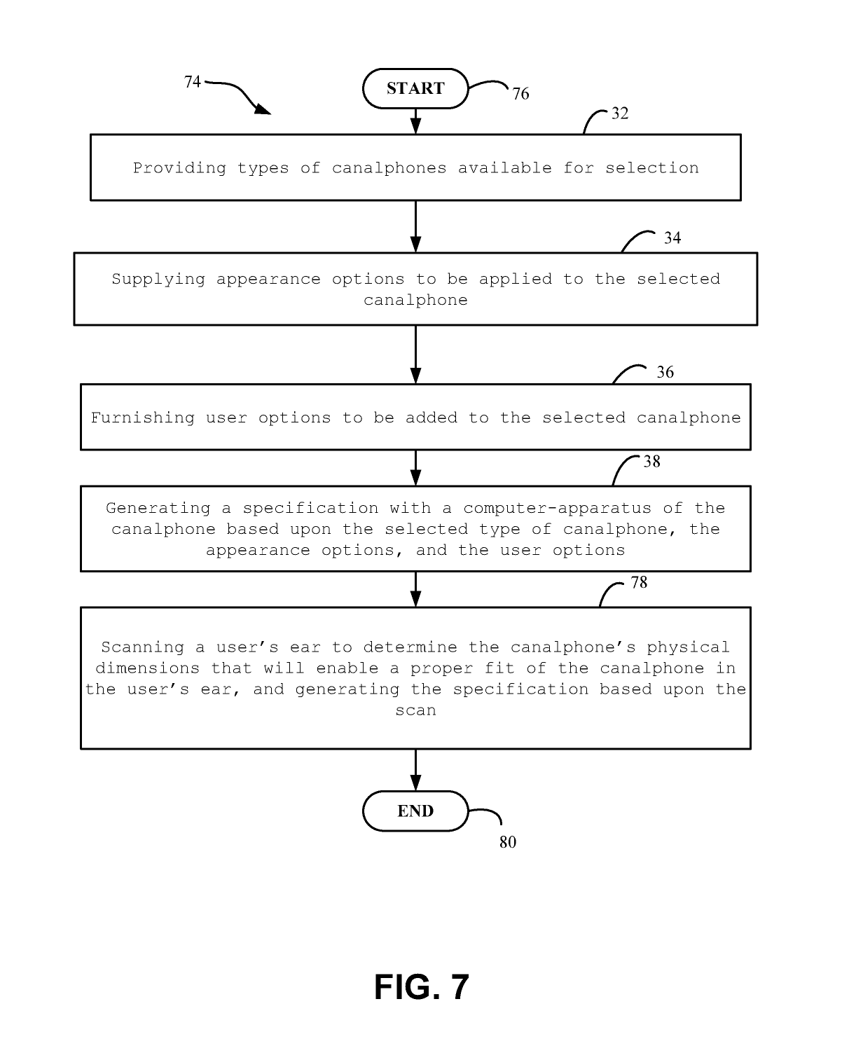

In another method embodiment, which is now described with reference to flowchart 74 of FIG. 7, the method begins at Block 76. The method may include the steps of FIG. 2 at Blocks 32-38. The method may also include scanning a user's ear to determine the canalphone's physical dimensions that will enable a proper fit of the canalphone in the user's ear, and generating the specification based upon the scan at Block 78. The method ends at Block 80.

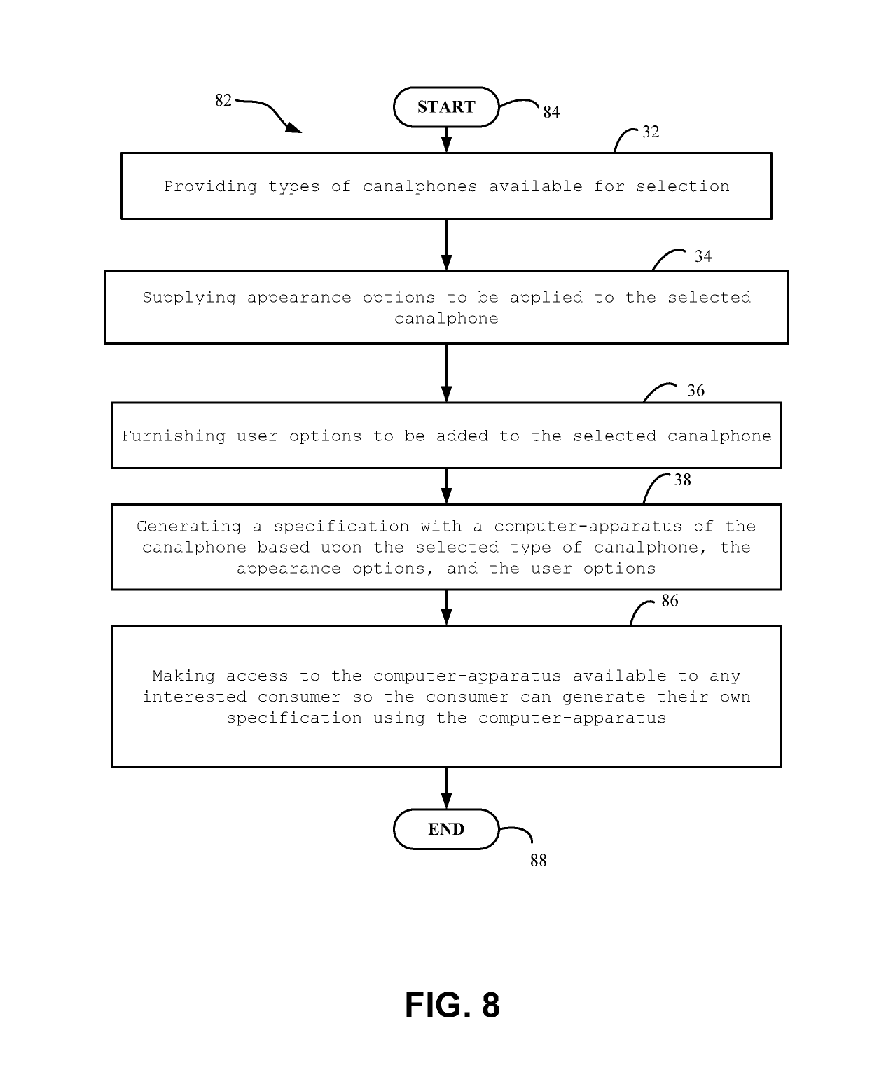

In another method embodiment, which is now described with reference to flowchart 82 of FIG. 8, the method begins at Block 84. The method may include the steps of FIG. 2 at Blocks 32-38. The method may also include making access to the computer-apparatus available to any interested consumer so the consumer can generate their own specification using the computer-apparatus at Block 86. The method ends at Block 88.

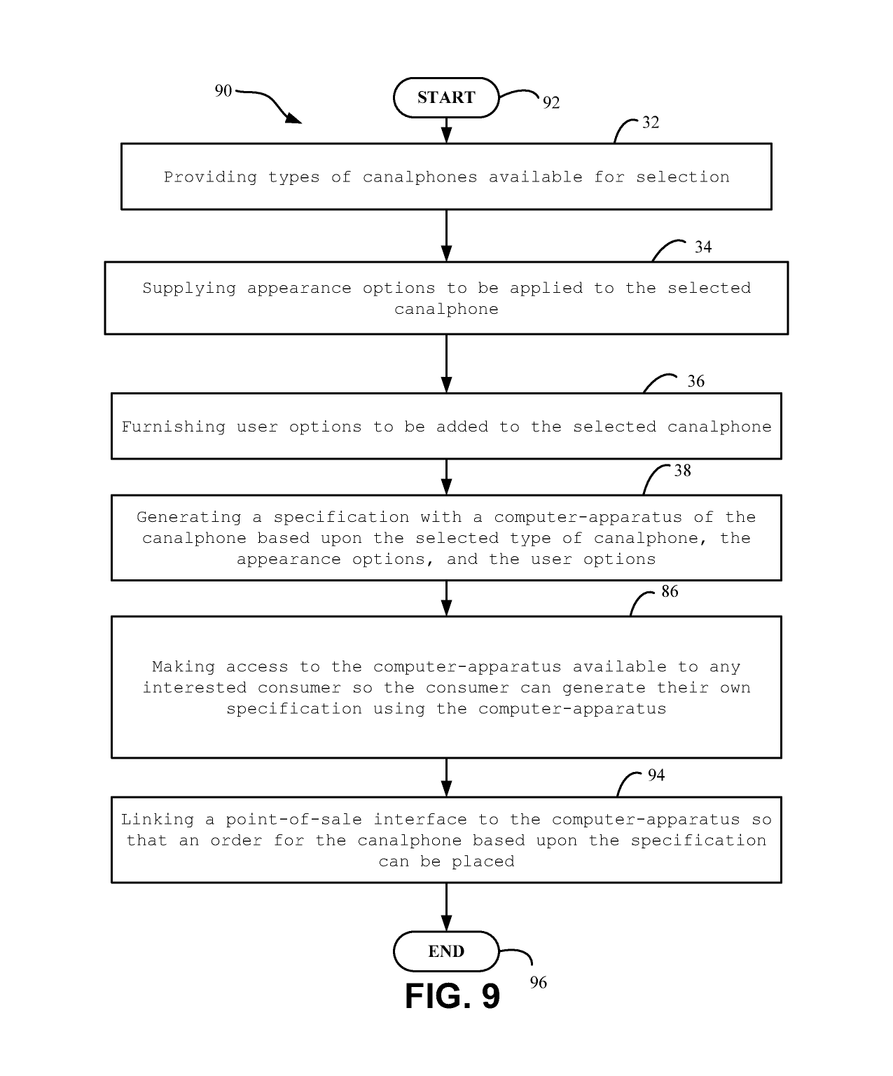

In another method embodiment, which is now described with reference to flowchart 90 of FIG. 9, the method begins at Block 92. The method may include the steps of FIG. 8 at Blocks 32-38 and 86. The method may also include linking a point-of-sale interface to the computer-apparatus so that an order for the canalphone based upon the specification can be placed at Block 94. The method ends at Block 96.

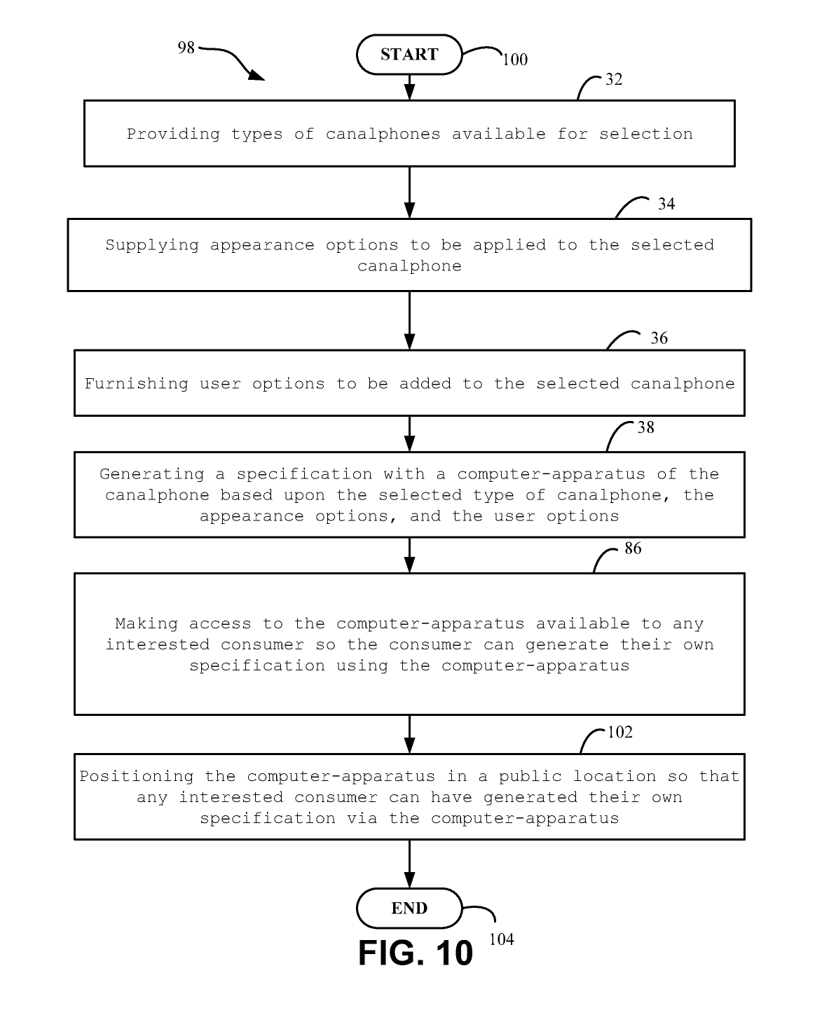

In another method embodiment, which is now described with reference to flowchart 98 of FIG. 10, the method begins at Block 100. The method may include the steps of FIG. 8 at Blocks 32-38 and 86. The method may also include positioning the computer-apparatus in a public location so that any interested consumer can have generated their own specification via the computer-apparatus at Block 102. The method ends at Block 104.

Another aspect is computer readable program codes coupled to tangible media to provide a canalphone 12 specification 18. The computer readable program codes may be configured to cause the program to provide types of canalphones 12 available for selection, and supply appearance options to be applied to the selected canalphone. The computer readable program codes may also furnish user options to be added to the selected canalphone 12, and generate a specification 18 with a computer-apparatus 16 of the canalphone based upon the selected type of canalphone, the appearance options, and the user options.

The computer readable program codes may further separate the types of canalphones 12 into groupings based upon their technical components 15. The computer readable program codes may additionally separate the appearance options into sets based upon color, no color, blacklight color, opacity, designer patterns, texture, and/or artwork.

The computer readable program codes may also enable a user to position and/or size the artwork on the canalphone 12. The computer readable program codes may further scan a user's ear to determine the canalphone's 12 physical dimensions that will enable a proper fit of the canalphone in the user's ear, and generate the specification 18 based upon the scan. The computer readable program codes may additionally link a point-of-sale interface 24 to the computer-apparatus 16 so that an order for the canalphone 12 based upon the specification 18 can be placed.

As will be appreciated by one skilled in the art, aspects may be embodied as a system, method, and/or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the embodiments are described above with reference to flowchart illustrations and/or block diagrams of methods, apparatus (systems) and computer program products according to the embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the various embodiments with various modifications as are suited to the particular use contemplated.

While the preferred embodiment has been described, it will be understood that those skilled in the art, both now and in the future, may make various improvements and enhancements which fall within the scope of the claims which follow. These claims should be construed to maintain the proper protection for the embodiments first described.

1-22. (canceled)

23. A system comprising:
an interface providing types of canalphones available for selection by a user based upon the types of canalphones' technical components including number of audio drivers carried by any selected type of canalphone;
an appearance options module executing on the interface that includes at least one of color, no color, blacklight color, opacity, designer patterns, texture, and artwork to be applied to the selected canalphone where the user selects appearance options;
an user options module executing on the interface that includes at least one of cord preferences, side selection, and ambient venting to be added to the selected canalphone where the user selects user options;
a specification generated with a computer-apparatus in communication with the interface, the specification including a user's selected type of canalphone, appearance options, and user options; and
a canalphone built by a manufacturer based upon the specification determined by the user where the specification provides the user's selected type of canalphone, appearance options, user options, physical parameters, and technical components that are used to build a physical version of the canalphone.

24. The system of claim 23 wherein the artwork is at least one of positioned and sized on the canalphone by the user.

25. The system of claim 23 further comprising a scanner that models portions of a user's ear to determine the canalphone's physical dimensions that are added to the specification as a manufacturing guide for the canalphone thus enabling proper fit of the canalphone in the user's ear.

26. The system of claim 23 further comprising a point-of-sale interface linked to the computer-apparatus so that an order for the canalphone based upon the specification can be placed.

27. The system of claim 23 wherein the specification includes materials used to construct the canalphone's housing based upon the user selected type of canalphone.

28. The system of claim 23 wherein the interface further separates types of canalphones into groupings based upon their technical components including at least one of audio crossovers and audio amplifiers.

29. The system of claim 23 wherein the specification comprises a digital file used by a computerized system to render portions of the canalphone as a physical product.

30. The system of claim 23 wherein the specification enables a user to select a type of canalphone at a given level of performance.

31. A system comprising:
an interface providing types of canalphones available for selection by a user based upon the types of canalphones' technical components including number of audio drivers carried by any selected type of canalphone;
an appearance options module executing on the interface that includes at least one of color, no color, blacklight color, opacity, designer patterns, texture, and artwork to be applied to the selected canalphone where the user selects appearance options and the artwork is at least one of positioned and sized on the canalphone by the user;
an user options module executing on the interface that includes at least one of cord preferences, side selection, and ambient venting to be added to the selected canalphone, and where the user selects user options;
a specification generated with a computer-apparatus in communication with the interface, the specification including a user's selected type of canalphone, appearance options, user options, and includes materials used to construct the canalphone's housing based upon the user selected type of canalphone; and
a canalphone built by a manufacturer based upon the specification determined by the user where the specification provides the user's selected type of canalphone, appearance options, user options, physical parameters, and technical components that are used to build a physical version of the canalphone.

32. The system of claim 31 further comprising a point-of-sale interface linked to the computer-apparatus so that an order for the canalphone based upon the specification can be placed.

33. The system of claim 31 wherein the interface further separates types of canalphones into groupings based upon their technical components including at least one of audio crossovers and audio amplifiers.

34. The system of claim 31 wherein the specification comprises a digital file used by a computerized system to render portions of the canalphone as a physical product.

35. A system comprising:
an interface providing types of canalphones available for selection by a user based upon the types of canalphones' technical components including number of audio drivers carried by any selected type of canalphone;
an appearance options module executing on the interface that includes at least one of color, no color, blacklight color, opacity, designer patterns, texture, and artwork to be applied to the selected canalphone where the user selects appearance options;
an user options module executing on the interface that includes at least one of cord preferences, side selection, and ambient venting to be added to the selected canalphone where the user selects user options;
a specification generated with a computer-apparatus in communication with the interface, the specification including a user's selected type of canalphone, appearance options, and user options, and the specification comprises a digital file used by a computerized system to render portions of the canalphone as a physical product;
a point-of-sale interface linked to the computer-apparatus so that an order for the canalphone based upon the specification can be placed; and
a canalphone built by a manufacturer based upon the specification determined by the user where the specification provides the user's selected type of canalphone, appearance options, user options, physical parameters, and technical components that are used to build a physical version of the canalphone.

36. The system of claim 35 wherein the artwork is at least one of positioned and sized on the canalphone by the user.

37. The system of claim 35 further comprising a scanner that models portions of a user's ear to determine the canalphone's physical dimensions that are added to the specification as a manufacturing guide for the canalphone thus enabling proper fit of the canalphone in the user's ear.

38. The system of claim 35 wherein the specification includes materials used to construct the canalphone's housing based upon the user selected type of canalphone.

39. The system of claim 35 wherein the interface further separates types of canalphones into groupings based upon their technical components including at least one of audio crossovers and audio amplifiers.
